(19) United States
(12) Patent Application Publication
(10) Pub. No.: US 2005/0283661 A1
(43) Pub. Date: Dec. 22, 2005

(54) Diagnostic extended mobile access

(75) Inventors: Hong W. Wong, Portland, OR (US); Hue V. Lam, Portland, OR (US); Feng Yang, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: INTEL CORPORATION

(21) Appl. No.: 10/864,270

(22) Filed: Jun. 8, 2004

(51) Int. Cl. G06F 11/00

(52) U.S. Cl. 714/12

(57) ABSTRACT

Systems and methods provide for using a microcontroller of an extended mobile access device to retrieve diagnostic data from a mobile computing system. In one embodiment, the device retrieves diagnostic data from a mobile computing system while the mobile computing system is in a closed-lid state. Other embodiments include retrieving diagnostic data while the mobile computing system is in an unbootable state or a power-off state. The diagnostic data and/or derivatives of the diagnostic data can be sent to a display of the device as well as sent to a network interface for transmission to a remote service center.

### BACKGROUND

1. Technical Field

One or more embodiments of the present invention generally relate to mobile computing. In particular, certain embodiments relate to diagnosing mobile computing systems.

2. Discussion

The increasing popularity of mobile computing systems such as notebook personal computers (PCs) and wireless “smart” phones is well documented. Unfortunately, a number of servicing-related challenges have accompanied the widespread popularity of these systems. Indeed, it has been determined that mobile computing systems are more prone to servicing problems than other types of systems. For example, some reports indicate that a significant number of notebook PCs leave the warehouse with operational problems requiring attention.

Another consequence of the widespread popularity of mobile computing systems is that an increasing number of end users lack the technical knowledge required to diagnose mobile computing systems. To further exacerbate the problem, the thermal, power and cost limitations associated with modern day mobile computing systems have eliminated the practicality of equipping the systems with a dedicated diagnostic module to assist consumers in the diagnostic process. As a result, diagnosis has typically been conducted by trained professionals. Such an approach essentially requires the consumer to ship or otherwise deliver the mobile computing system to a servicing center. This solution can be slow, costly, and inconvenient to the consumer.

While minor problems with mobile computing systems may be diagnosed remotely, a number of difficulties remain. For example, under conventional approaches the mobile computing system must be bootable and must have network access in order to implement such a solution. Furthermore, certain reduced power states such as the “closed-lid” sleep state are not currently compatible with conventional remote diagnostic solutions. Power conservation can be very important for mobile computing systems, which have strict design limitations, as already noted.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1A is a block diagram of an example of a system according to one embodiment of the invention;

FIG. 1B is a block diagram of an example of a system according to an alternative embodiment of the invention;

FIG. 2 is a schematic of an example of power sharing/switching logic according to one embodiment of the invention;

FIG. 3 is a flowchart of an example of a process of managing diagnostic power according to one embodiment of the invention;

FIG. 4 is a flowchart of an example of a method of diagnosing a mobile computing system according to one embodiment of the invention; and

FIG. 5 is a flowchart of an example of a process of using a device microcontroller to retrieve diagnostic data from a mobile computing system according to one embodiment of the invention.

### DETAILED DESCRIPTION

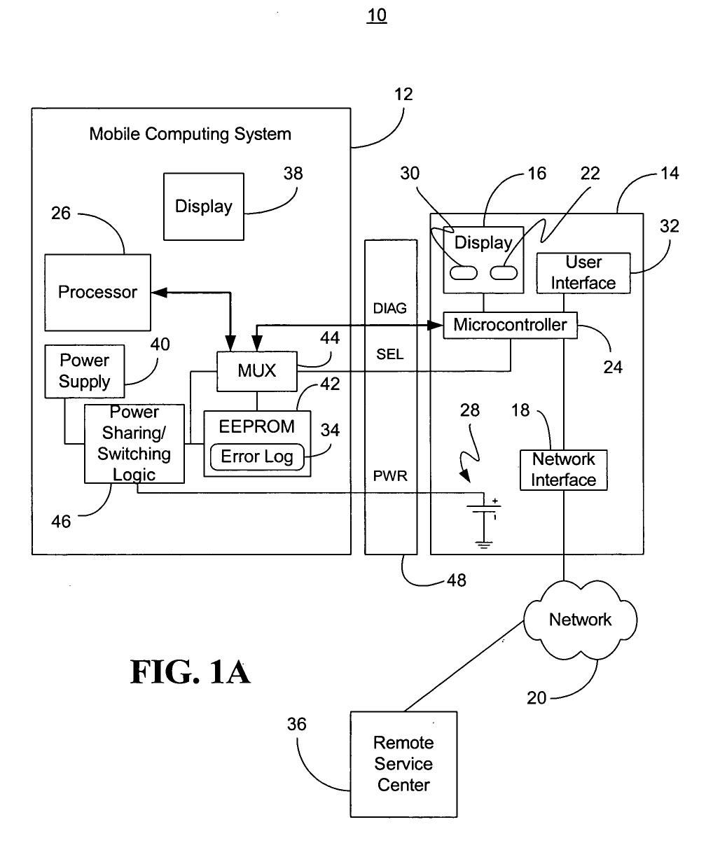

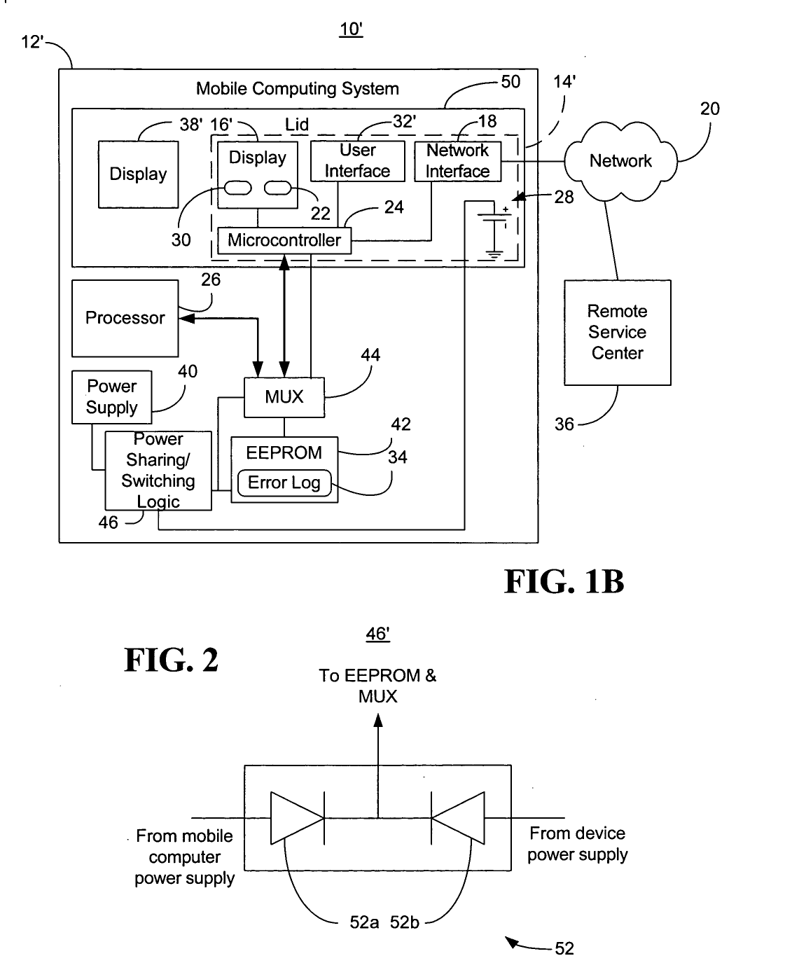

FIG. 1A shows an architecture 10 having a mobile computing system 12 such as a notebook personal computer (PC), wireless “smart” phone, and so on, and a device 14 having an embedded microcontroller 24. The microcontroller 24 may be a complete microprocessor system-on-chip (SOC). For example, the microcontroller 24 could include a central processing unit (CPU), local random access memory (RAM), local read only memory (ROM) or erasable programmable ROM (EPROM/Flash memory), clock and control circuits, and serial and parallel input/output (I/O) ports. The illustrated microcontroller 24 has limited functionality, however, in comparison to a processor 26 of the mobile computing system 12. For example, the microcontroller 24 may be limited to performing only a subset of the functions available from the processor 26. On the other hand, the microcontroller 24 may require much less power than the processor 26, due to the limited functionality of the microcontroller 24. As a result, the device 14 can be used to achieve significant power savings for the overall architecture 10, while at the same time maintaining full operability of certain features.

In one embodiment, the device 14 is an extended mobile access (EMA) device, which can provide “closed-lid” access to certain data within the mobile computing system 12. For example, the device 14 may be able to retrieve personal data including, but not limited to, e-mail data, calendar data, address data, to do list data and memorandum data from the mobile computing system 12 while the mobile computing system 12 is in a sleep state, which provides significant power savings. The illustrated microcontroller 24 can present the personal data to the user as a personal information message 22 on a display 16 of the device 14, send the personal information message 22 to a network interface 18 for transmission to a remote device (not shown) that is accessible through a network 20, or send the personal information message 22 via some other interface (not shown) to another location (not shown). Although the network interface 18 is shown as being incorporated into the device 14, the network interface 18 may also be part of the mobile computing system 12. Indeed, eliminating the network interface 18 from the device 14 and making use of the networking capabilities of the mobile computing system 12 can further reduce costs.

The microcontroller 24 can also retrieve diagnostic data such as an error log 34 from the mobile computing system 12 while the mobile computing system is in a reduced power state such as a sleep state or an unbootable state. In particular, the illustrated device 14 has a power supply such as direct current (DC) power source 28, which can supply power “PWR” to the mobile computing system 12. The microcontroller 24 initiates the data retrieval process by asserting the signal “SEL” to the mobile computing system and reads the diagnostic data “DIAG” from the mobile computing system. The microcontroller can then send a diagnostic message 30 to the device display 16 based on the diagnostic data. The diagnostic message 30 can include the diagnostic data, summarize the diagnostic data or be otherwise derived from the diagnostic data. In one example, the diagnostic message 30 is merely a regurgitation of the error log 34. By using the microcontroller 24 to retrieve both diagnostic data and personal information data, the architecture 10 is able to avoid the added cost of a module that is dedicated to diagnostics. Indeed, the cost of incorporating the illustrated diagnostics solution into an architecture already equipped with an EMA device is quite low.

The microcontroller 24 can also send the diagnostic message 30 to the network interface 18 based on the diagnostic data. The network interface could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002). In some cases, a remote service center 36 can also be coupled to the network 20, where the remote service center is able to receive diagnostic messages from the device 14. Trained professionals or other knowledge-based systems could be located at the remote service center 36 to evaluate the diagnostic messages.

In this regard, it should be noted that the diagnostic data can be retrieved from the mobile computing system 12 while the mobile computing system is in a reduced power state (or power off state). Examples of a reduced power state can include an unbootable state in which the mobile computing system 12 consumes little or no power, a closed-lid state in which only core components of the mobile computing system 12 are kept active, and so on. Indeed, the mobile computing system could be wholly inoperable so long as the diagnostic data has been stored before entering the state of inoperability. Under conventional approaches these circumstances would typically lead to the need for the mobile computing system 12 to be delivered physically to the remote service center 36 (or other servicing location). The illustrated architecture therefore provides a faster and less expensive way to diagnose mobile computing systems.

Retrieval of the diagnostic data can be initiated in a number of different ways. For example, the device 14 can also include a user interface 32, such as a keypad, microphone, touchscreen, etc., where an individual may use the user interface 32 to initiate retrieval of the diagnostic data. In such a case, the microcontroller 24 receives a diagnostics request from the user interface 32 and retrieves the diagnostic data in response to the request from the user interface 32 by initiating the data retrieval process. Alternatively, the remote service center 36 may initiate the retrieval of diagnostic data over the network 20 by sending a diagnostics request to the microcontroller 24 by way of a network interface such as the network interface 18. The microcontroller 24 then retrieves the diagnostic data in response to the request from the network interface 18 by issuing the data retrieval signal. In yet another example, the microcontroller 24 may periodically self-initiate retrieval of the diagnostics data.

The illustrated mobile computing system 12 has a display 38, a system power supply 40 and power sharing/switching logic 46, where the power sharing/switching logic 46 is coupled to the system power supply 40 as well as the device power source 28. The mobile computing system 12 also has a memory such as an electrically erasable programmable read only memory (EEPROM) 42 coupled to the power sharing/switching logic 46 and a multiplexer 44 coupled to the power sharing/switching logic 46 and the EEPROM 42. Other types of memory such as EPROM and RAM may be substituted for the EEPROM 42, and other types of switches such as field effect transistors (FETs) and complementary metal oxide semiconductor (CMOS) technology can be substituted for the multiplexer 44. The EEPROM 42 stores the diagnostic data, which is shown as the error log 34 in the illustrated embodiment. The diagnostic data can be written to the EEPROM by any appropriate component of the mobile computing system 12. For example, the basic input/output system (BIOS, not shown) of the mobile computing system 12 could provide for logging of errors in the EEPROM 42. Thus, at power on system test (POST), the various software and/or hardware components of the mobile computing system 12 can be directed to document any errors in the EEPROM 42. If the multiplexer 44 receives the data retrieval signal “SEL” from the microcontroller 24, the multiplexer 44 routes the diagnostic data from the EEPROM 42 to the device 14 via the bus “DIAG”.

The architecture 10 shown in FIG. 1A has a docking connector 48 disposed between the device 14 and the mobile computing system 12. The illustrated docking connector 48 transfers power “PWR” and the data retrieval signal “SEL” from the device 14 to the mobile computing system 12. The docking connector 48 may also transfer the diagnostic data bus “DIAG” from the mobile computing system 12 to the device 14.

FIG. 1B shows an alternative architecture 10′ in which the device 14′ is disposed within a housing of the mobile computing system 12′. In particular, the illustrated mobile computing system 12′ has a lid 50 that contains the device 14′ and a system display 38′. The lid 50 could be the foldable portion of a notebook PC or the upper portion of a wireless phone having a “clam-shell” design. The system display 38′ is positioned on an “inner” surface of the lid 50 so that the system display 38′ is obscured when the lid 50 is closed. The device 14′, on the other hand, can have a device display 16′ that is positioned on an opposing “outer” surface of the lid 50 so that the device display 16′ is not obscured when the lid 50 is closed. Closing the lid 50 enables the mobile computing system 12′ to enter a sleep state that provides significant power conservation. Retrieval of the error log 34 can be initiated by the user interface 32′, network interface 18 or microcontroller 24 while the mobile computing system 12′ is in the sleep state. Retrieval of the error log 34 may also be initiated while the mobile computing system 12′ is in an unbootable or otherwise inoperable state, as already discussed.

Turning now to FIG. 2, one approach to implementing the power sharing/switching logic is shown in greater detail at 46′. In particular, the illustrated power sharing/switching logic 46′ includes a pair of diodes 52 (52a, 52b), where each diode 52 has its cathode terminal coupled to the power pins of EEPROM 42 (FIGS. 1A and 1B) and the multiplexer 44 (FIGS. 1A and 1B). The anode terminal of the diode 52a is coupled to the system power supply 40 (FIGS. 1A and 1B), where the anode terminal of the diode 52b is coupled to the device power source 28. Thus, the diodes 52 are forward biased to provide whatever power is available to the EEPROM/multiplexer. Although the illustrated power sharing logic 46′ uses diodes, other components such as transistors may also be used.

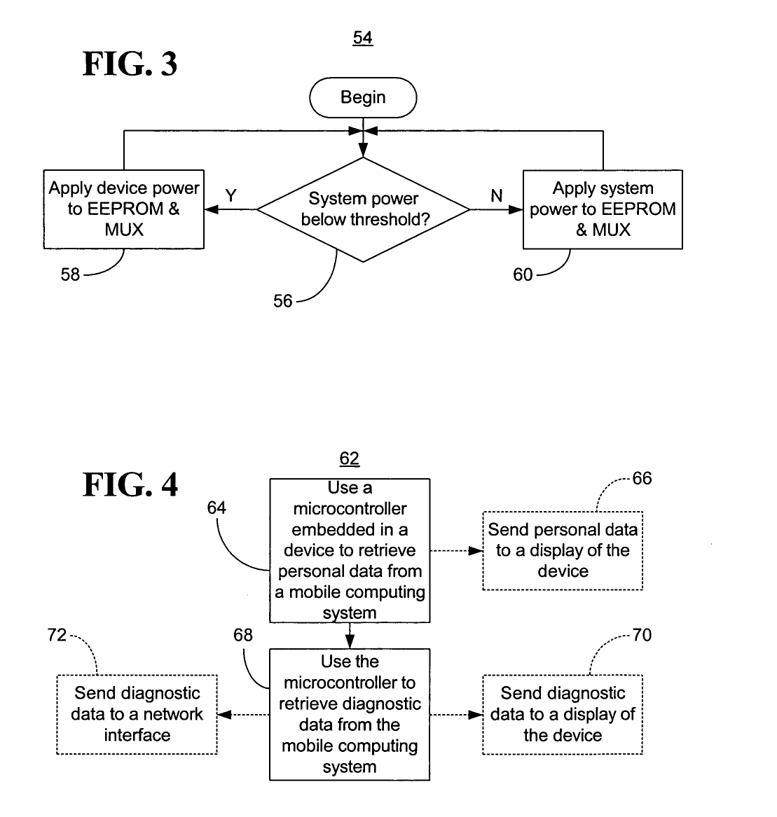

FIG. 3 illustrates an alternative approach to implementing the power sharing/switching logic at method 54. The method 54 may be incorporated into the power sharing/switching logic 46 (FIGS. 1A and 1B) using any suitable hardware and/or software programming technique. In particular, processing block 56 provides for determining whether the system power supply is providing power that is below a power threshold. If so, power from the device power source is applied to the EEPROM and the multiplexer at block 58. Otherwise, block 60 provides for applying power from the system power supply to the EEPROM and the multiplexer.

Turning now to FIG. 4, a method 62 of diagnosing a mobile computing system is shown. The method 62 can be implemented using any suitable hardware and/or software programming technique. For example, the method 62 can be incorporated into an application specific integrated circuit (ASIC) as transistor-transistor logic (TTL) or CMOS technology, into a set of instructions to be stored in a memory such as read only memory (ROM), compact disk ROM (CDROM), random access memory (RAM), flash memory, etc., or any combination thereof. In particular, the illustrated processing block 64 provides for using a microcontroller of an extended mobile access device to retrieve personal data from a mobile computing system. As already noted, the personal data can include items such as e-mail data, calendar data, address data, to do list data and memorandum data. If requested or otherwise desired, the personal data can be sent to a display of the device at block 66.

Block 68 provides for using the microcontroller to retrieve diagnostic data from the mobile computing system. As already discussed, using the same microcontroller to retrieve diagnostic as well as personal information data can obviate a number of cost considerations associated with diagnosing mobile computing systems. Block 70 provides for sending the diagnostic data and/or a derivative of the diagnostic data to the device display and block 72 provides for sending the diagnostic data and/or its derivative to a network interface.

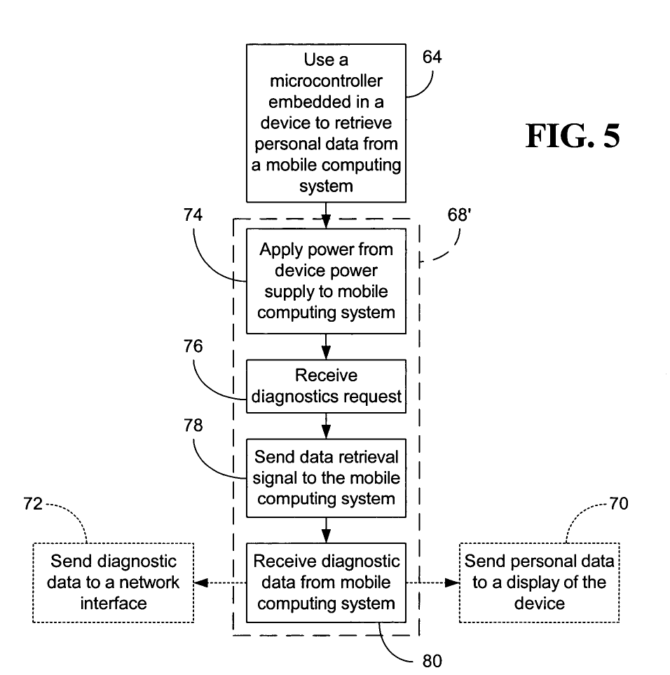

FIG. 5 shows one approach to retrieving diagnostic data from a mobile computing system in greater detail at block 68′. In particular, the device power is applied to the mobile computing system at block 74. A diagnostics request is received at block 76 and a data retrieval signal is sent to the mobile computing system at block 78. When the diagnostic data is received from the mobile computing system at block 80, the diagnostic data and/or its derivative can be sent to the device display and/or a network interface as already discussed.

Thus, the principles described herein provide a number of advantages over conventional techniques. For example, retrieving diagnosis data from a mobile computing system while the mobile computing system is in a reduced power state such as a closed-lid state, power off or an unbootable state, enables consumers without a great deal of technical knowledge to diagnose the system. As a result, the consumer may be able to relay the diagnosis to a trained professional or computerized knowledgebase and obtain solutions such as downloadable patches and drivers without the need for delivering the mobile computing system to a service center. Furthermore, using an extended mobile access device microcontroller, which may already be part of the bill of materials (BOM), provides a low cost solution to diagnosing mobile computing systems.

The term “coupled” is used herein to refer to any type of connection, direct or indirect, that enables communication or energy transfer to take place across the interface in question. Thus, coupling might include intermediate components. The coupling might also provide for electronic, electromagnetic, optic and other forms of communication.

Those skilled in the art can appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1. A method comprising:
using a microcontroller of an extended mobile access device to retrieve diagnostic data from a mobile computing system.

2. The method of claim 1, wherein using the microcontroller includes:
applying power from a power supply of the device to the mobile computing system;
sending a data retrieval signal to the mobile computing system; and
receiving the diagnostic data from the mobile computing system.

3. The method of claim 2, wherein sending the data retrieval signal includes sending the data retrieval signal while the mobile computing system is in an unbootable state.

4. The method of claim 2, wherein sending the data retrieval signal includes sending the data retrieval signal while the mobile computing is in at least one of a closed-lid operating state and a power off state.

5. The method of claim 1, further including sending a diagnostic message to a network interface based on the diagnostic data.

6. The method of claim 5, further including receiving a diagnostics request from the network interface, the diagnostic data being retrieved in response to the request.

7. The method of claim 5, wherein sending the diagnostic message includes sending the diagnostic message to a wireless network interface.

8. The method of claim 1, further including sending a diagnostic message to a display of the device based on the diagnostic data.

9. The method of claim 8, further including receiving a diagnostics request from a user interface of the device, the diagnostic data being retrieved in response to the request.

10. The method of claim 1, further including using the microcontroller to retrieve personal data from the mobile computing system, the personal data including data selected from a group comprising e-mail data, calendar data, address data, to do list data and memorandum data.

11. The method of claim 1, wherein using the microcontroller of the device to retrieve the diagnostic data includes using the microcontroller to retrieve an error log from the mobile computing system.

12. A device comprising:
a microcontroller to retrieve diagnostic data from a mobile computing system while the mobile computing system is in at least one of an unbootable state, a power-off and a closed-lid state.

13. The device of claim 12, further including a power supply to apply power to the mobile computing system, the microcontroller to send a data retrieval signal to the mobile computing system and receive the diagnostic data from the mobile computing system.

14. The device of claim 12, further including a network interface, the microcontroller to receive a diagnostics request from the network interface, retrieve the diagnostic data in response to the request and send a diagnostic message to the network interface based on the diagnostic data.

15. The device of claim 12, further including:
a user interface, the microcontroller to receive a diagnostics request from the user interface and retrieve the diagnostic data in response to the request; and
a device display, the microcontroller to send a diagnostic message to the device display based on the diagnostic data.

16. The device of claim 12, wherein the microcontroller is to retrieve personal data from the mobile computing system, the personal data to include data selected from a group comprising e-mail data, calendar data, address data, to do list data and memorandum data.

17. The device of claim 12, wherein the device includes an extended mobile access device.

18. An architecture comprising:
a mobile computing system; and
an extended mobile access device having a microcontroller to retrieve diagnostic data from the mobile computing system.

19. The architecture of claim 18, wherein the device further includes a power supply to apply power to the mobile computing system, the microcontroller to send a data retrieval signal to the mobile computing system and receive the diagnostic data from the mobile computing system.

20. The architecture of claim 19, wherein the microcontroller is to send the data retrieval signal while the mobile computing system is in an unbootable state.

21. The architecture of claim 19, wherein the microcontroller is to send the data retrieval while the mobile computing system is in a closed-lid state.

22. The architecture of claim 18, further including a network interface, the microcontroller to send a diagnostic message to the network interface based on the diagnostic data.

23. The architecture of claim 18, wherein the mobile computing system includes:
a system power supply;
power sharing logic coupled to the system power supply and to a power supply of the device;
an electrically erasable programmable read only memory (EEPROM) coupled to the power sharing logic, the EEPROM to store the diagnostic data; and
a multiplexer coupled to the power sharing logic, the device and the EEPROM, the multiplexer to route the diagnostic data from the EEPROM to the device in response to a data retrieval signal from the device.

24. The architecture of claim 23, further including a docking connector disposed between the device and the mobile computing system, the docking connector to transfer power and the data retrieval signal from the device to the mobile computing system and transfer the diagnostic data from the mobile computing system to the device.

25. The architecture of claim 23, wherein the device is disposed within a housing of the mobile computing system.

26. The architecture of claim 23, wherein the power sharing logic includes:
a first diode having an anode terminal coupled to the system power supply and a cathode terminal coupled to the EEPROM and the multiplexer; and
a second diode having an anode terminal coupled to the power supply of the device and a cathode terminal coupled to the EEPROM and the multiplexer.

27. The architecture of claim 23, wherein the mobile computing system includes a notebook personal computer.

28. The architecture of claim 23, wherein the mobile computing system includes a wireless phone.

29. The architecture of claim 18, wherein the microcontroller is to retrieve personal data from the mobile computing system, the personal data to include data selected from a group comprising e-mail data, calendar data, address data, to do list data and memorandum data.

30. A method comprising:
applying power from a power supply of an extended mobile access device to a mobile computing system;
using a microcontroller of the device to retrieve personal data from the mobile computing system while the mobile computing system is in a closed-lid state, the personal data including data selected from a group comprising e-mail data, calendar data, address data, to do list data and memorandum data;
receiving a diagnostics request;
sending a data retrieval signal to the mobile computing system in response to the diagnostics request while the mobile computing system is in at least one of a closed-lid state, a power-off and an unbootable state;
receiving diagnostic data from the mobile computing system, the diagnostic data including an error log; and
sending a diagnostic message to the network interface based on the diagnostic data.

31. The method of claim 30, wherein sending the diagnostic request to the network interface includes sending the diagnostic message to a wireless network interface.

31. The method of claim 30, further including sending the diagnostic message to a display of the device.
